(19) United States
(12) Patent Application Publication
(10) Pub. No.: US 2009/0013165 A1
(43) Pub. Date: Jan. 8, 2009

(54) PORTABLE USB DEVICE THAT BOOTS A COMPUTER AS A SERVER

(76) Inventors: David Q. Chow, San Jose, CA (US); Tzu-Yih Chu, San Jose, CA (US); Frank I. Yu, Palo Alto, CA (US); Ben W. Chen, Fremont, CA (US); Ming-Shiang Shen, Hsin Chuang (TW)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/846,476

(22) Filed: Aug. 28, 2007

Related U.S. Application Data
(63) Continuation-in-part of application No. 11/838,192, filed on Aug. 13, 2007.
Application No. 11/838,192 is a continuation-in-part of application No. 11/624,667, filed on Jan. 18, 2007.
Application No. 11/624,667 is a continuation-in-part of application No. 11/040,326, filed on Jan. 20, 2005.
Application No. 11/040,326 is a continuation-in-part of application No. 09/478,720, filed on Jan. 6, 2000, now Pat. No. 7,257,714.
Application No. 09/478,720 is a continuation-in-part of application No. 10/762,934, filed on Jan. 21, 2004, now abandoned.
Application No. 10/762,934 is a continuation-in-part of application No. 10/002,652, filed on Oct. 19, 2001, now Pat. No. 7,103,765.

(51) Int. Cl. G06F 15/177

(52) U.S. Cl. 713/2

(57) ABSTRACT

Techniques for booting a host computer from a portable storage device with customized settings have been described herein. According to one embodiment, in response to detecting a portable storage device inserted into a first host computer having a first operating environment provided by a first operating system (OS) installed in the first host computer, rebooting the first host computer into a second operating environment using a second OS image stored in the portable device. In addition, a personal configuration file stored in the portable device is extracted to configure the second operating environment of the first host computer, such that the user of the portable storage device can operate the second host computer in view of the personal working environment. Other methods and apparatuses are also described.

### RELATED APPLICATIONS

This application is a CIP (continuation-in-part) of co-pending U.S. patent application Ser. No. 11/838,192, entitled “Multi-Partition USB Device that Re-Boots a PC to an Alternative Operating System for Virus Recovery”, filed Aug. 13, 2007, which is a CIP of co-pending U.S. patent application Ser. No. 11/624,667, filed Jan. 18, 2007, U.S. patent application Ser. No. 11/040,326, filed Jan. 20, 2005, and U.S. patent application Ser. No. 09/478,720, entitled “Electronic Data Storage Medium with Fingerprint Verification Capability”, filed Jan. 6, 2000, now U.S. Pat. No. 7,257,714.

This application is also a CIP of co-pending U.S. patent application Ser. No. 10/762,934, entitled “Method and System for Providing a Modular Server on USB Flash Storage”, filed Jan. 21, 2004, which is a CIP of U.S. patent application Ser. No. 10/002,652, filed Oct. 19, 2001, now U.S. Pat. No. 7,103,765.

The disclosure of the above-identified applications and patents is incorporated by reference herein in its entirety.

### FIELD OF THE INVENTION

The present invention relates generally to computer systems. More particularly, this invention relates to rebooting a computer from an operating system stored in a portable device.

### BACKGROUND

Personal computer systems have become common tools in modern society. Portable computer systems such as laptop or notebook computers are gaining more popularity because of their portable convenience. A user may carry a portable computer to a remote location without losing the customized operating environment that the user is familiar with. Thus, most users would prefer to utilize their own computer at any given time without having to sacrifice their individual operating environment or personal settings such as, for example, operating system, email client, word processor, etc.

However, under certain circumstances, it may be considered inconvenient to carry an item such as a notebook computer during a trip because it may still be considered to be “heavy.” Another inconvenience to the user would be fear of loss, theft or having their personal computer hacked, by a hacker. A remote place, such as a hotel in a foreign country, may provide a remote computer for a hotel guest to use; however, the operating environment of the remote computer may be different than the one on the home computer of the user, such as, for example, different operating systems, different native languages, or different applications, etc. Therefore, if the user wants to use a remote or foreign computer, the user is limited to whatever features or settings are available at the remote or foreign computer. In addition, by using a foreign computer, a user may take concern about leaving personal or confidential information behind at the foreign computer.

### SUMMARY OF THE DESCRIPTION

Techniques for booting a host computer from a portable storage device with customized settings have been described herein. According to one embodiment, in response to detecting a portable storage device inserted into a first host computer having a first operating environment provided by a first operating system (OS) installed in the first host computer, rebooting the first host computer into a second operating environment using a second OS image stored in the portable device. In addition, a personal configuration file stored in the portable device is extracted to configure the second operating environment of the first host computer, such that the user of the portable storage device can operate the second host computer in view of the personal working environment.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 is a block diagram illustrating a process of establishing an operating environment of a computer system according to one embodiment of the invention.

FIG. 2 is a block diagram illustrating an example of a portable storage device according to one embodiment of the invention.

FIG. 3 is a block diagram illustrating an example of a portable storage device having multiple partitions in accordance with one embodiment of the invention.

FIG. 4 is a block diagram illustrating an example of personal working environment image according to one embodiment of the invention.

FIG. 5 is a block diagram illustrating an example of a user partition according to one embodiment of the invention.

FIG. 6 is a flow diagram illustrating a process for establishing an operating environment of a host computer according to one embodiment of the invention.

FIG. 7 is a block diagram of a data processing system which may be used with one embodiment of the invention.

### DETAILED DESCRIPTION

Techniques for booting a host computer from a portable storage device with customized settings are described herein. In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

According to certain embodiments, a portable storage device such as a USB (universal serial bus) device may be used to store any personal configuration and/or operating environment associated with a user's own computer. Such a storage device may be carried by the user to travel to a remote location and used with a foreign computer that may have a different operating environment or settings. The customized configuration of an operating environment associated with the user may be used to configure the foreign computer into a customized operating environment that is similar to the one available at the user's own computer.

The original configurations of the foreign computer are not utilized. Instead, the foreign computer is booted from an operating system (OS) image stored in the portable device and utilizes a personal configuration file that has captured the personal settings of the user to configure the operating environment at the foreign computer. As a result, a user would operate any foreign computer and utilize their own personalized operating environment such as if the user were operating their computer at home. Note that throughout this application, a portable storage device having a USB interface is utilized as an example of a portable storage device. However, it is not so limited; other portable storage devices having other interfaces, such as, for example, IEEE-1394 (also referred to as Firewire) or PCMCIA (personal computer memory card international association), may also be applied.

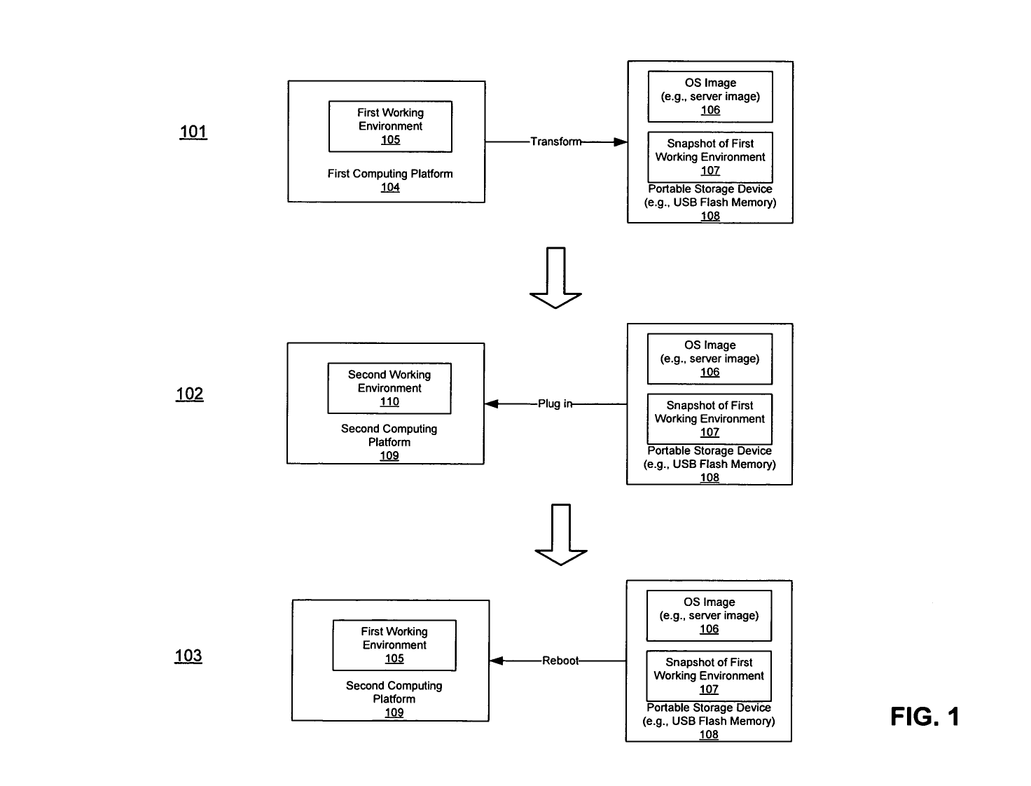

FIG. 1 is a block diagram illustrating a process of establishing an operating environment of a computer system according to one embodiment of the invention. Referring to FIG. 1, initially, at stage 101, a user of a USB storage device 108 is inserted into a local computer 104 which is operating in a first working environment 105. The first working environment 105 may be customized by the user having certain user's favorite or preferred settings or applications. For example, the first working environment 105 may include the user's customized desktop settings, email client, media player, word processor, or antivirus/SPAM settings, etc.

When the USB storage device is inserted into the first computer 104, the first working environment 105 may be captured and stored in the USB storage device 108 as a personal configuration file 107. According to one embodiment, upon detecting an insertion of a foreign USB device, the host computer responds with checking on a “Bootable” or “Launchable” partition on the foreign USB device. That triggers the “launch” of a “Utility application software” within the host computer, and a “User Menu” comes up on the computer screen. It shows a multiple selection list for an end user to select or pick up all the application suite, OS configurations, work environment set-up specific parameters, client software, such as email, Web configurations, favor Multi-media app-lets. With one-bottom click or an activation, the Host computer starts collecting all related configurations, parameter settings, and “wrap around” to produce a “Work image” of the Host computer work environment, which is stored in a “User specified partition” of the foreign USB storage device.” For another example, in a Windows operating environment available from Microsoft Corporation of Redmond, Wash., a utility application may “walk through” certain areas of the Windows registry to obtain installation and configuration information of certain applications that are running within the Windows operating system. This information may then be compressed into a relatively small size configuration file 107 stored in the USB storage device 108. The configuration file 107 may be encrypted using a variety of security measures since the configuration file 107 may include certain personal confidential information. In addition, the USB storage device 108 may further include an operating system image 106 (e.g., a server OS image) which may be used to reboot an external computer into a server without using an OS inside of the external computer.

Subsequently at stage 102, the user may carry the USB storage device 108 and insert into a remote or foreign computer 109, where computer 109 may operate in a second operating environment 110. The second operating environment 110 may operate under the same or different operating system as of computer 104. However, the personal configuration of the operating environment (also referred to herein as working environment) may be different from the one in computer 104. When the USB storage device 108 is inserted into the second computer 109 via a USB interface of the computer 109, the USB storage device 108 is detected and recognized, for example, via a plug-n-play feature of the operating system running therein. The USB storage device 108 is then mounted by the operating system (e.g., file system) as a mass storage.

Thereafter at stage 103, a reboot process may be initiated by the user manually or automatically. During the reboot, either a warm boot or a cold boot, the BIOS code is executed to perform certain initialization operations (e.g., POST or power-on self-test). After the BIOS detects the inserted USB storage device, the BIOS may further detect a boot sector located within the USB storage device. For example, the BIOS may launch a local control program (not shown) of the USB storage device which in turn locates and executes the boot sector of the USB device to boot up the computer 109 using the OS image 106. Thus, instead of booting up computer 109 using the original OS of computer 109, the BIOS invokes the local control program of the USB storage device to take over the booting sequence control. As a result, computer 109 is booted using the OS image 106.

Once the computer 109 boots up using OS image 106 to establish an operating environment (e.g., desktop environment), the personal configuration file 107 is extracted to configure the operating environment to include certain personal settings of the user. As a result, the operating environment of computer 109 may have a working environment similar to the one of computer 104, which the user is familiar with.

Once the user has finished using the remote computer 109 (e.g., leaving the hotel or a client site), the user may unplug the portable storage device 108 from the host computer 109 and be ready to go home or go to another remote site. In response to the portable storage device 108 removed from the host computer 109, according to one embodiment, certain “garbage collection” operations may be performed on the host computer 109. For example, certain temporary files (e.g., cached files or temporary files downloaded from a Web page) stored at a storage of the host computer 109 may be erased. As a result, any possible personal confidential information associated with the user may be removed from the remote computer 109.

Furthermore, according to one embodiment, if the user modifies any settings of the working environment (e.g., changes of the address/phone book or Web links/bookmarks, etc.) while operating the host computer 109, prior to removing the portable storage device 108 from the host computer 109, at least a portion of the modified working environment settings may be saved back (e.g., synchronized) to the portable storage device 108. Thus, when a user carrying the portable storage device 108 goes back to the user's own computer (e.g., local or home computer), the modified working environment can be restored from the portable storage device 108 back to the user's own computer (e.g., computer 104).

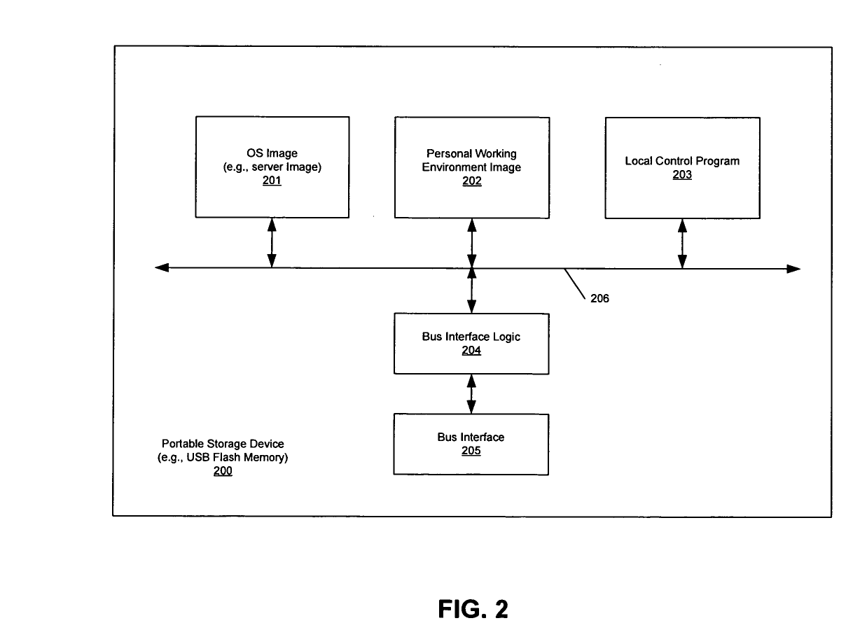

FIG. 2 is a block diagram illustrating an example of a portable storage device according to one embodiment of the invention. For example, portable storage device 200 may be implemented as part of portable storage device 108 of FIG. 1. Referring to FIG. 2, portable storage device 200 includes, but is not limited to, an OS image 201, a personal working environment image 202, and local control program or programs coupled to each other via a bus or interconnect 206. The portable storage device 200 further includes a bus interface logic 204 and bus interface 205 which are used to interface the portable storage device 200 with an external device (e.g., external host computer) via proper bus protocols (e.g., USB protocols). OS image 201 may be implemented as part of OS image 106 of FIG. 1 and personal working environment image 202 may be implemented as part of working environment image 107 of FIG. 1.

As described above, when the portable storage device 200 is inserted into an external host computer, the OS image 201 may be used to boot, via local control program 203, an external host computer without using the original OS of the external host computer. Once the host computer boots up, the personal working environment image 202 is extracted and used to configure the operating environment of the host computer to have a predetermined working environment associated with a user of the portable storage device 200.

In addition, the portable storage device 200 may optionally include other control logic. In one embodiment, the other control logic is managed by the local control program 203. Further, portable storage device 200 may includes a variety of connectors (not shown), including an initialization connector, a shut-down connector, a power control connector, a status LED connector, a DC power LED connector, and/or a LCD display connector, etc. However, in another embodiment, the other control logic could include other components. The connectors can be coupled to LEDs (not shown) and an LCD display (not shown) integrated with the portable storage device 200. Further detailed information regarding operations of these components can be found in the above incorporated by reference applications.

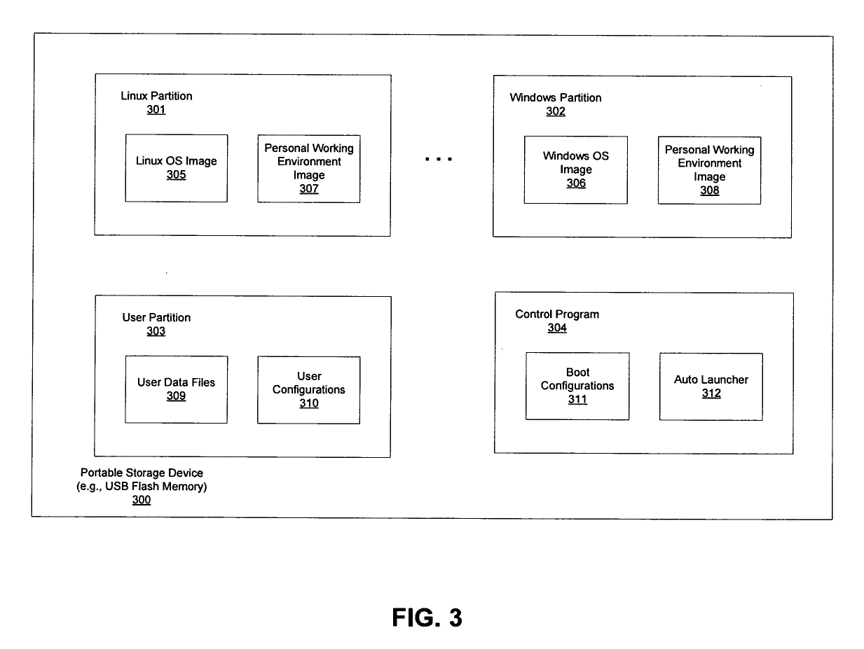

According to certain embodiments, the portable storage device may be implemented in a single partition or multiple partitions. FIG. 3 is a block diagram illustrating an example of a portable storage device having multiple partitions in accordance with one embodiment of the invention. For example, portable storage device 300 may be implemented as part of portable storage device 200 of FIG. 2. Referring to FIG. 3, in one embodiment, portable storage device 300 includes multiple partitions for storing multiple different OS images such as Linux partition 301 for Linux OS related files and Windows partition 302 for Windows OS related files. Each of the OS related partitions includes a OS image (e.g., images 305-306) used to boot a host computer into a corresponding OS environment and a personal working environment image (e.g., images 307-308) to customize or personalize the corresponding OS environment. The portable storage device 300 may further include a user partition 303 having user data files 309 and user configurations 310 and a control program partition 304 having a boot configuration 311 and auto launcher program 312.

Specifically, referring to FIG. 3, Linux partition 301 stores Linux OS image 305, which includes the OS routines, definitions, modules, and drivers that are loaded into a computer's main memory just before running Linux. Linux-based user programs and data can also be stored in Linux partition 301, such as Linux anti-virus program which can scan for and clean viruses and other malware.

Microsoft Windows partition 302 includes Microsoft Windows OS image 306, which includes the OS routines, definitions, modules, applications-programming-interface (API) interpreters, and drivers that are loaded into a computer's main memory just before running Microsoft Windows. Microsoft Windows based user programs and related data can also be stored in Microsoft Windows partition 40, such as Microsoft Windows applications.

User partition 303 stores use data files 309 which may be accessed by any operating system when each OS has a corresponding driver or program that can open files of that file-type. User configurations 310 can include configuration data that may be specific to one operating system or another, or may include generic configuration information.

Control program 304 is a partition of flash memory in the USB device that stores a control program and related data that is executed by the USB device itself. The USB device then notifies the host computer of the presence of a bootable device desiring to auto-launch an application. The host computer may then transfer control to the bootable device for execution. Boot configurations 311 includes configuration data about the partitions stored in the flash memory of the USB device, such as the association of partitions 301-302 with certain buttons described above, and which partition's data to transfer to a host computer and what action or program to run when each of buttons is activated.

Auto-launcher 312 is a program that helps copy data from one of partitions 301-302 to a host computer being booted when the portable storage device 300 is inserted into the host computer and recognized by the OS that is running on the host computer. Auto-launcher 312 may be a Launch Pad application that check the data type and brings up a list or menu of application software that end users can click on to activate their favorite application software for further action. For example, if the data is MP3 type, then auto-launcher 312 brings up a list of Media player or decoder software for end users to click and choose. Other configurations may exist.

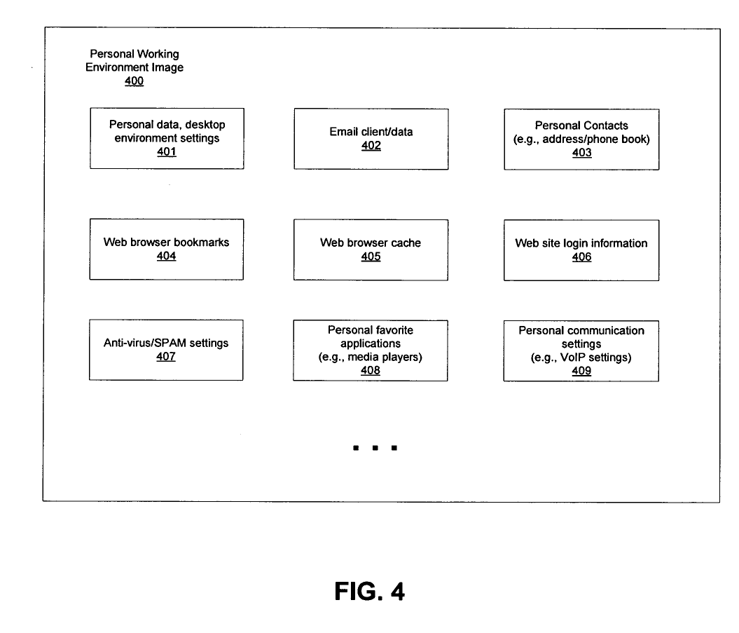

FIG. 4 is a block diagram illustrating an example of personal working environment image according to one embodiment of the invention. For example, personal working environment 400 may be implemented as part of working environment images 307-308 of FIG. 3. Referring to FIG. 4, in this example, personal working environment 400 includes information representing a variety of personal or customized settings, including personal data and desktop settings 401, email client and settings 402, and personal contacts 403 such as an address book and/or phone book. The personal working environment 400 may further include certain Web browser settings such as, for example, Web browser bookmarks 404, Web browser cache 405, and Web site login information 406, etc. The personal working environment 400 may further include other applications such as anti-virus/SPAM applications or settings 407, personal favorite applications 408 such as media players, and personal communication settings 409 such as VoIP or instant messaging settings, etc. Other personal items may also be included.

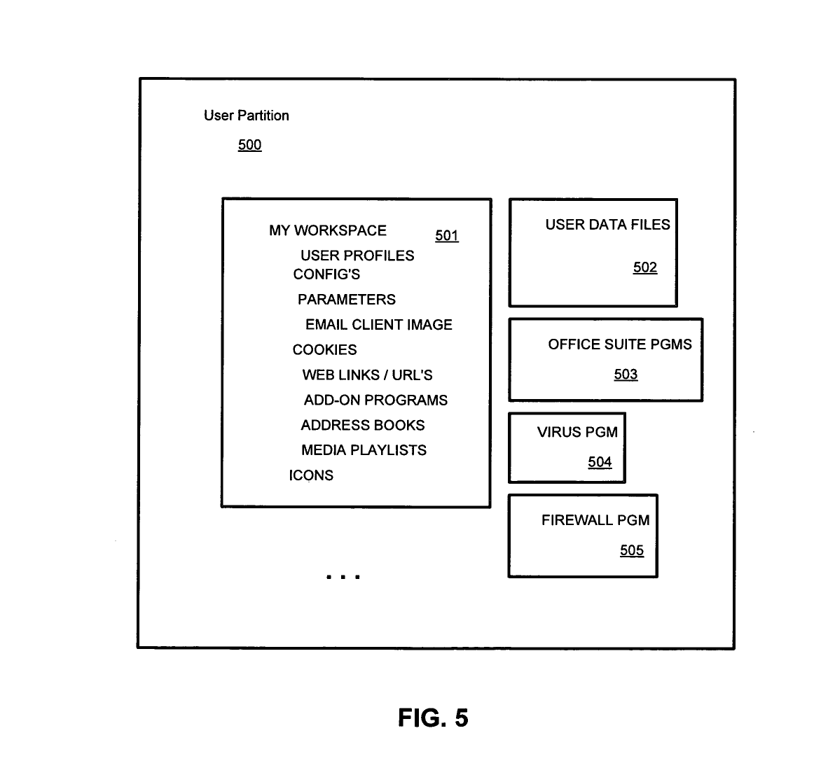

FIG. 5 is a block diagram illustrating an example of a user partition according to one embodiment of the invention. For example, user partition 500 may be implemented as part of user partition 303 of FIG. 3. Referring to FIG. 5, user partition 500 stores user data files 502 which may be accessible in one or both operating systems, depending on applications available in the operating systems. Office suite programs 503 may include Microsoft Windows office software such as word processing, spreadsheet, contact, and scheduling software, or office suite software for Linux or another operating system. Virus program 504 can detect and remove viruses while running on Linux. Firewall program 505 protects the user's computer from external attacks when connected to a network such as the Internet. User configurations 501 can include a wide variety of user configuration data for one or for both operating systems. User profiles or workspaces stored in user configurations 52 may include parameters, email client images, web cookies, links, and universal resource locators (URL's), web browser add-on programs, address books, media playlists and settings, icons, and other user-specific data. Other components may also be included.

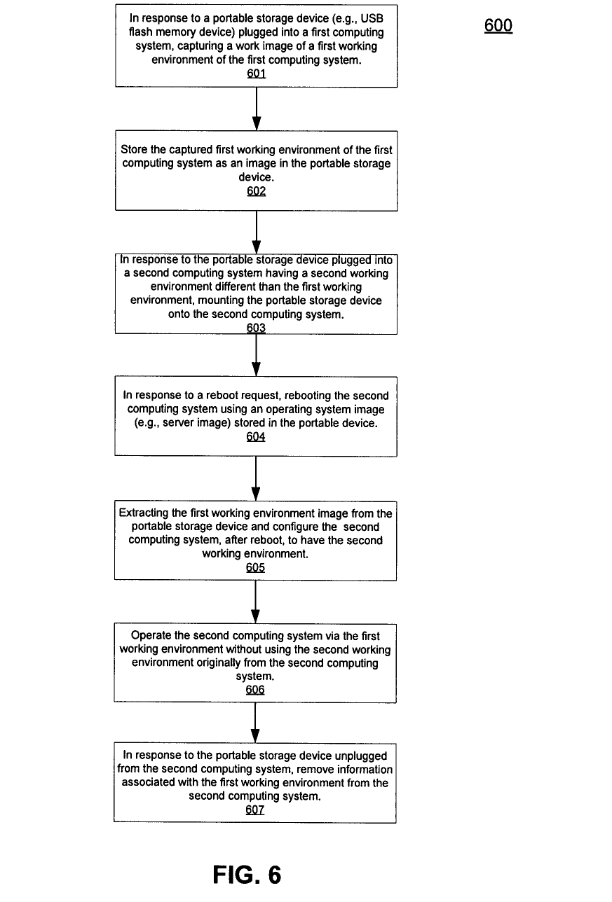

FIG. 6 is a flow diagram illustrating a process for establishing an operating environment of a host computer according to one embodiment of the invention. Note that process 600 may be performed by processing logic which may include software, hardware, or a combination of thereof. For example, process 600 may be performed by systems as shown in FIGS. 1-2. Referring to FIG. 6, in response to a portable storage device (e.g., USB flash memory device) inserted into a first host computer, at block 601, processing logic captures a snapshot of a first working environment (e.g., as shown in FIG. 4) of the first host computer. At block 602, the captured working environment is stored with optional compression and/or encryption in the portable storage device. Subsequently in response to the portable storage device inserted into a second host computer which may have a different operating environment as of the first host computer, at block 603, the portable storage device is mounted into the file system of the second host computer.

At block 604, in response to a reboot request, the second host computer is rebooted using an OS image stored in the portable storage device. Once the second host computer is rebooted, at block 605, the first working environment image stored in the portable storage device is extracted and used to configure the operating environment of the second host computer. At block 606, the second host computer is operated in a first working environment rather than the original second working environment associated with the second host computer.

Once the user has finished using the second computer (e.g., leaving the hotel or a client site), the user may unplug the portable storage device from the second host computer and be ready to go home or go to another remote site. In response to the portable storage device removed from the second host computer, at block 607, processing logic may perform certain “garbage collection” operations on the second host computer. For example, certain temporary files (e.g., cached files or temporary files downloaded from a Web page) stored at a storage of the second host computer may be erased.

Furthermore, according to one embodiment, if the user modifies any settings of the working environment (e.g., changes of the address/phone book or Web links/bookmarks), prior to removing the portable storage device from the second host computer, at least a portion of the modified working environment settings may be saved back (e.g., synchronized) to the portable storage device. Thus, when a user carrying the portable storage device goes back to the user's own computer (e.g., local or home computer), the modified working environment can be restored back to the user's own computer. Other operations may also be performed.

Note that techniques described above in accordance with embodiments of the present invention can be applied to a variety of mass storage devices such as Serial ATA FLASH hard drive, IDE FLASH hard drive, SCSI FLASH hard drive and Ethernet FLASH hard drive. In addition, a FLASH controller in accordance with the present invention also applies to FLASH memory cards such as Express Card, Mini PCI Express Card, Secure Digital Card, Multi Media Card, Memory Stick Card and Compact FLASH card. Finally, a system in accordance with the present invention also applies to the other serial buses such as PCI Express bus, Serial ATA bus, IEEE 1394 bus and Ethernet bus. Accordingly, many modifications may be made by one of ordinary skill in the art without departing from the spirit and scope of the appended claims.

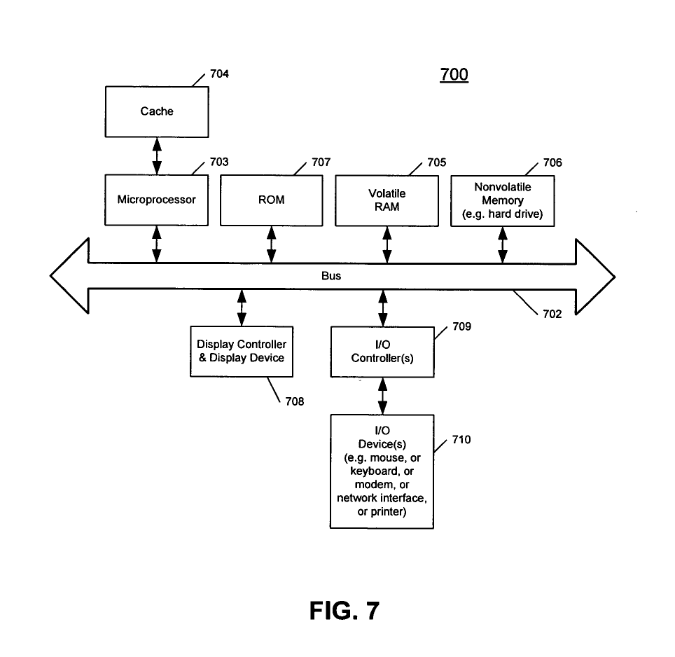

FIG. 7 is a block diagram of a data processing system which may be used with one embodiment of the invention. For example, the system 700 shown in FIG. 7 may be used as a host computer system such as host computer systems 104 and/or 109 of FIG. 1. Note that while FIG. 7 illustrates various components of a computer system, it is not intended to represent any particular architecture or manner of interconnecting the components; as such details are not germane to the present invention. It will also be appreciated that network computers, handheld computers, cell phones, and other data processing systems which have fewer components or perhaps more components may also be used with the present invention. The computer system of FIG. 7 may, for example, be an Apple Macintosh computer or an IBM compatible PC.

As shown in FIG. 7, the computer system 700, which is in a form of a data processing system, includes a bus or interconnect 702 coupled to a processor 703 and a ROM 707, a volatile RAM 705, and a non-volatile memory 706. Processor 703 may include multiple processors and/or core logics that constitute central processing units (CPUs) of the system and thus, control the overall operations of the system. According to certain embodiments, processor 703 accomplish this by executing software stored in any of the memories 705-707, such as, for example, applications and operating system, etc. Processor 703 may include, one or more programmable general-purpose or special-purpose microprocessors, digital signal processors (DSPs), programmable controllers, application specific integrated circuits (ASICs), programmable logic devices (PLDs), or the like, or a combination of such devices.

The processor 703, which may be, for example, an Intel processor or a PowerPC processor, is coupled to cache memory 704 as shown in the example of FIG. 7. The bus 702 interconnects these various components together and also interconnects these components 703 and 705-707 to a display controller and display device 708, as well as to input/output (I/O) devices 710, which may be mice, keyboards, modems, network interfaces, printers, and other devices which are well-known in the art.

Typically, the input/output devices 710 are coupled to the system through input/output controllers 709. The volatile RAM 705 is typically implemented as dynamic RAM (DRAM) which requires power continuously in order to refresh or maintain the data in the memory. The non-volatile memory 706 is typically a magnetic hard drive, a magnetic optical drive, an optical drive, a DVD RAM, a Flash memory, or other type of memory system which maintains data even after power is removed from the system. Typically, the non-volatile memory will also be a random access memory, although this is not required.

While FIG. 7 shows that the non-volatile memory is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 702 may include one or more buses connected to each other through various bridges, controllers, and/or adapters, as is well-known in the art. In one embodiment, the I/O controller 709 includes a USB (Universal Serial Bus) adapter for controlling USB peripherals. Alternatively, I/O controller 709 may include an IEEE-1394 adapter, also known as FireWire adapter, for controlling FireWire devices. Other components may also be included.

Thus, techniques for booting a host computer from a portable storage device with customized settings have been described herein. Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

A machine-readable medium may include any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method for establishing an operating environment of a computer, the method comprising:
in response to detecting a portable storage device inserted into a first host computer having a first operating environment provided by a first operating system (OS) installed in the first host computer, rebooting the first host computer into a second operating environment using a second OS image stored in the portable device;
extracting from a personal configuration file stored in the portable device to obtain settings of a personal working environment associated with a user of the portable storage device, wherein the personal configuration file is generated by extracting the personal working environment from a second host computer different than the first host computer; and
configuring the second operating environment of the first host computer using the obtained settings of the personal working environment, such that the user of the portable storage device can operate the second host computer in view of the personal working environment.

2. The method of claim 1, wherein the portable storage device is a USB (universal serial bus) compatible storage device, and wherein the portable storage device is inserted into a USB interface of the first host computer.

3. The method of claim 2, further comprising:
mounting the portable storage device into a file system of the first host computer prior to rebooting the first host computer; and
during rebooting the first host computer, a BIOS (basic input/output system) of the first host computer invoking a control program stored in the portable storage device to take over a booting process of the first host computer,
wherein the control program of the portable storage device, when invoked from the BIOS of the first host computer, is configured to extract the second OS image from the portable storage device and to boot the first host computer using the second OS without using information from a boot sector of the first host computer.

4. The method of claim 3, further comprising:
prior to inserting the portable storage device into the first host computer, inserting the portable storage device into the second host computer;
capturing personal settings associated with the second operating environment of the second host computer; and
downloading the captured personal settings into the portable storage device as the personal configuration file which is used to configure the second operating environment of the first host computer after rebooting the first host computer using the second OS image from the portable storage device.

5. The method of claim 4, wherein the second host computer is a local computer associated with the user of the portable storage device, and wherein the first host computer is a remote computer with respect to the user of the portable storage device.

6. The method of claim 5, wherein the first host computer after being configured using the personal configuration file, when operated, has an appearance of an operating environment similar to an appearance of an operating environment of the second host computer.

7. The method of claim 5, further comprising:
detecting that the portable storage device is unplugged from the first host computer; and
in response to the detection, removing one or more files associated with the personal working environment that are temporarily stored in a storage of the first host computer during operating the first host computer in the second operating environment.

8. The method of claim 7, wherein the personal configuration file comprises personal setting information selected from at least one of:
personal data and/or desktop settings;
email client and the associated data;
personal contacts including at least one of an address book and phone book;
Web browser settings including at least one of bookmarks, browser cache, and Web site login information;
anti-virus settings;
media players; and
personal communications settings.

9. A computer-readable medium having computer instructions stored therein, which when executed by a processor, cause the processor to perform a method for establishing an operating environment of a computer, the method comprising:
in response to detecting a portable storage device inserted into a first host computer having a first operating environment provided by a first operating system (OS) installed in the first host computer, rebooting the first host computer into a second operating environment using a second OS image stored in the portable device;
extracting from a personal configuration file stored in the portable device to obtain settings of a personal working environment associated with a user of the portable storage device, wherein the personal configuration file is generated by extracting the personal working environment from a second host computer different than the first host computer; and
configuring the second operating environment of the first host computer using the obtained settings of the personal working environment, such that the user of the portable storage device can operate the second host computer in view of the personal working environment.

10. The computer-readable medium of claim 9, wherein the portable storage device is a USB (universal serial bus) compatible storage device, and wherein the portable storage device is inserted into a USB interface of the first host computer.

11. The computer-readable medium of claim 10, wherein the method further comprises:
mounting the portable storage device into a file system of the first host computer prior to rebooting the first host computer; and
during rebooting the first host computer, a BIOS (basic input/output system) of the first host computer invoking a control program stored in the portable storage device to take over a booting process of the first host computer,
wherein the control program of the portable storage device, when invoked from the BIOS of the first host computer, is configured to extract the second OS image from the portable storage device and to boot the first host computer using the second OS without using information from a boot sector of the first host computer.

12. The computer-readable medium of claim 11, wherein the method further comprises:
prior to inserting the portable storage device into the first host computer, inserting the portable storage device into the second host computer;
capturing personal settings associated with the second operating environment of the second host computer; and
downloading the captured personal settings into the portable storage device as the personal configuration file which is used to configure the second operating environment of the first host computer after rebooting the first host computer using the second OS image from the portable storage device.

13. The computer-readable medium of claim 12, wherein the second host computer is a local computer associated with the user of the portable storage device, and wherein the first host computer is a remote computer with respect to the user of the portable storage device.

14. The computer-readable medium of claim 13, wherein the first host computer after being configured using the personal configuration file, when operated, has an appearance of an operating environment similar to an appearance of an operating environment of the second host computer.

15. The computer-readable medium of claim 13, wherein the method further comprises:
detecting that the portable storage device is unplugged from the first host computer; and
in response to the detection, removing one or more files associated with the personal working environment that are temporarily stored in a storage of the first host computer during operating the first host computer in the second operating environment.

16. The computer-readable medium of claim 15, wherein the personal configuration file comprises personal setting information selected from at least one of:
personal data and/or desktop settings;
email client and the associated data;
personal contacts including at least one of an address book and phone book;
Web browser settings including at least one of bookmarks, browser cache, and Web site login information;
anti-virus settings;
media players; and
personal communications settings.

17. A portable storage device, comprising:
a first storage area to store a first operating system (OS) image;
a second storage area to store a personal configuration file having information associated with personal settings associated with a user of the portable storage device, wherein the personal configuration file is generated based on personal information obtained from a first host computer and downloaded to the second storage area when the portable storage device is inserted into the first host computer having a first operating environment; and
a bus interface logic coupled to the first storage area and second storage area, wherein when the portable device is inserted into a second host computer having a second operating environment and the second host computer is rebooted, the bus interface logic causes the second host computer to boot from the first OS image from the first storage area of the portable device to have a first operating environment rather than the second operating environment, and
wherein after reboot, the first operating environment of the second host computer is configured using the personal configuration file from the second storage area to enable the first operating environment of the second host computer to operate in a personal settings similar to the first host computer.

18. The portable storage device of claim 17, wherein the bus interface logic is a USB (universal serial bus) compatible logic.

19. The portable storage device of claim 17, wherein the first host computer is a home computer of the user of the portable storage device and wherein the second host computer is a foreign computer with respect to the user of the portable storage device.

20. The portable storage device of claim 17, wherein the personal configuration file comprises personal setting information selected from at least one of:
personal data and/or desktop settings;
email client and the associated data;
personal contacts including at least one of an address book and phone book;
Web browser settings including at least one of bookmarks, browser cache, and Web site login information;
anti-virus settings;
media players; and
personal communications settings.
